(19) United States
(12) Patent Application Publication
(10) Pub. No.: US 2007/0090920 A1
(43) Pub. Date: Apr. 26, 2007

(54) Apparatus and Method for Controlling Access to Remotely Located Equipment

(76) Inventors: James M. Canter, Austin, TX (US); Daraius K. Hathiram, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/277,272

(22) Filed: Mar. 23, 2006

Related U.S. Application Data
(60) Provisional application No. 60/729,106, filed on Oct. 22, 2005.

(51) Int. Cl. G05B 19/00

(52) U.S. Cl. 340/5.65; 340/5.7; 340/5.26

(57) ABSTRACT

An apparatus and method for controlling access to remotely located equipment are disclosed. The method includes receiving a request at an access control module (ACM) from a host controller to provide a serial number associated with the ACM and communicating the serial number to the host controller. In response to communicating the serial number to the host controller, the ACM receives a calculated unique key from the host controller and compares the calculated unique key with a unique key stored in a microprocessor associated with the ACM. If the calculated unique key matches the stored unique key, the ACM generates an actuation signal and communicates the actuation signal to a fail-safe switch assembly in order to activate at least one component of an electronic locking structure.

### RELATED APPLICATIONS

This application claims the benefit of U.S. Provisional Patent Application entitled “Apparatus And Method For Controlling Access To Remotely Located Equipment,” application Ser. No. 60/729,106 filed Oct. 22, 2005.

This application is related to copending Patent Application entitled “Apparatus And Method For Controlling And Monitoring Access To A Storage Container”, application Ser. No. ______, filed ______ claiming priority to U.S. Provisional Patent Application Ser. No. ______ filed ______ and copending Patent Application entitled “Apparatus And Method For Attaching An Electronic Module To A Lock Assembly ” application Ser. No. ______, filed ______ claiming priority to U.S. Provisional Patent Application Ser. No. ______ filed ______.

### TECHNICAL FIELD

The present disclosure is related to controlling access to remotely located equipment such as vending machines and more particularly to controlling access to any component or system that includes an electrical switch.

### BACKGROUND OF THE DISCLOSURE

Vending machine manufacturers have developed new and innovative vending equipment in response to market needs and vending operator demands. These innovations have been, for the most part, adopted by the vending industry. This trend has been influenced by the accelerating rate of technological innovation in electronic and electro-mechanical component industries. Availability of new technologies has given vending machine manufacturers appropriate tools to address many requirements of vending operators. Advances in electronics are now enabling the use of computer controls and data acquisition systems within each vending machine. Some of the latest vending machines make it possible for vending operators to download data and information associated with sales, inventory, and equipment status on-site onto portable computers or transmit vending machine data and information to a central location such as a network operations center. Many vending machines include vending machine controllers based on the International Multi-drop Bus Interface Standards developed by the National Automatic Merchandising Association (NAMA).

A wide variety of electronic security systems including electromechanical locks and electronic keys have been developed for use in controlling access to remotely located equipment such as vending machines. Such electronic keys and electromechanical locks often include one or more electronic switches.

Electronic switches such as addressable switches have been used to control access to vending machines and other types of remotely located equipment. For example, Maximum Integrated Products, Inc. manufactures and sells one-wire addressable switches that allow peripherals to be interfaced with an electronic controller or computer using a single signal wire. Operational commands or electronic signals and codes used to operate commercially available addressable switches and other types of electronic switches may be publicly available from multiple sources such as the Internet. As a result, such operational commands or electronic signals and codes may be used by an unauthorized person to break into remotely located equipment by fishing one or more electrical wires out of the remotely located equipment and using a handheld controller to pass the code through the wires. Electronic switches may also be overpowered by applying excessive amounts of electrical power to such wires to break one or more switches and energize an associated solenoid to open a lock.

### SUMMARY OF THE DISCLOSURE

In accordance with the present disclosure, the disadvantages and problems associated with controlling access to remotely located equipment such as vending machines have been substantially reduced or eliminated. In a particular embodiment, an access control module generates an activation signal and communicates the signal to a fail-safe switch assembly that activates at least one component of an electronic locking structure.

In accordance with one embodiment, an access control module (ACM) operable to prevent unauthorized activation of an electronic locking structure to gain access to remotely located equipment may include an addressable switch operable to receive an electronic signal having a computed unique key or code from a host controller and/or a network operations center. The addressable switch may be interfaced with a microprocessor operable to store a serial number and a unique key associated with the ACM, compare the computed unique key with the stored unique key, and generate an actuation signal if the computed unique key matches the stored unique key. For some applications the addressable switch may be a one-wire switch. The microprocessor may be interfaced with a fail-safe switch assembly operable to close at least one switch to activate portions of at least one component of the electronic locking structure in response to the actuation signal provided by the microprocessor.

In accordance with another embodiment of the present disclosure a method for controlling access to remotely located equipment includes receiving a request at an access control module (ACM) from a host controller to provide a serial number associated with the ACM and communicating the serial number to the host controller. In response to communicating the serial number to the host controller, the ACM receives a calculated unique key from the host controller and compares the calculated unique key with a unique key stored in a microprocessor associated with the ACM. If the calculated unique key matches the stored unique key, the ACM generates an actuation signal and communicates the actuation signal to a fail-safe switch assembly in order to activate at least one component of an electronic locking structure.

Important technical advantages of certain embodiments of the present disclosure include an access control module (ACM) that provides overpower protection for an associated electronic locking structure. Components of the ACM may cooperate with each other to prevent excessively high voltages (an electrical attack) from overpowering associated electronic circuits and placing the electronic locking structure in an “unlocked” or “unsecured” position. For some applications, the access control module and associated electronic locking structure may fail to a closed state or secured state if excessive amounts of electrical power are applied and one or more components of the access control module are destroyed.

Another important technical advantage of certain embodiments of the present disclosure includes an access control module (ACM) that provides a unique key which will only open and activate an associated electronic locking structure in response to a matching unique key calculated by a host controller. The use of unique electronic signals or private signals minimizes or prevents unauthorized activation of an associated electronic locking structure. As a result, even if one ACM is compromised or “reverse engineered” and the unique key for the one ACM is determined, other ACM's incorporating teachings of the present disclosure will not be compromised since each ACM has its own, respective unique key. A complete electronic transaction associated with unlocking and opening remotely located equipment having an ACM may be recorded and decoded or analyzed without compromising other ACM's incorporating teachings of the present disclosure.

For some embodiments, an ACM may receive a request for a serial number associated with that ACM. Based upon the serial number, an associated host controller may compute a nonpublic, unique key. The ACM may then activate or fire a solenoid to open an associated electronic lock if the computed unique key generated by the host controller matches the unique key stored in the ACM.

For some applications an access control module (ACM) incorporating teachings of the present disclosure may eliminate or reduce the amount of “armor” or reinforcement used to protect remotely located equipment from an unauthorized entry or attack. Without such ACM's, doors and other portions of enclosures associated with remotely located equipment may be reinforced to block or limit access to electrical power cables and electrical wiring associated with operating the remotely located equipment. Electrical cables, wiring and associated electronic components may be “armored” or shielded to prevent unauthorized access by communicating electrical signals to an associated locking mechanism. Including such ACM's in remotely located equipment may reduce initial manufacturing costs and/or maintenance costs over the service life of the remotely located equipment.

All, some, or none of these technical advantages may be present in various embodiments of the present disclosure. Other technical advantages will be readily apparent to one skilled in the art from the following figures, descriptions, and claims.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram depicting one embodiment of a vending machine and an electronic lock which may be opened in accordance with teachings of the present disclosure;

FIG. 2 illustrates a schematic block diagram showing one example of an access control module incorporating teachings of the present disclosure;

FIG. 3A illustrates a schematic drawing showing portions of an electronic circuit and associated components satisfactory for use with an access control module incorporating teachings of the present disclosure;

FIG. 3B illustrates a schematic drawing showing portions of an electronic circuit and associated components satisfactory for use with an access control module incorporating the teachings of the present disclosure; and

FIG. 4 illustrates a schematic drawing showing a block diagram of interaction between an access control module and a host controller in accordance with teachings of the present disclosure.

### DETAILED DESCRIPTION OF THE DISCLOSURE

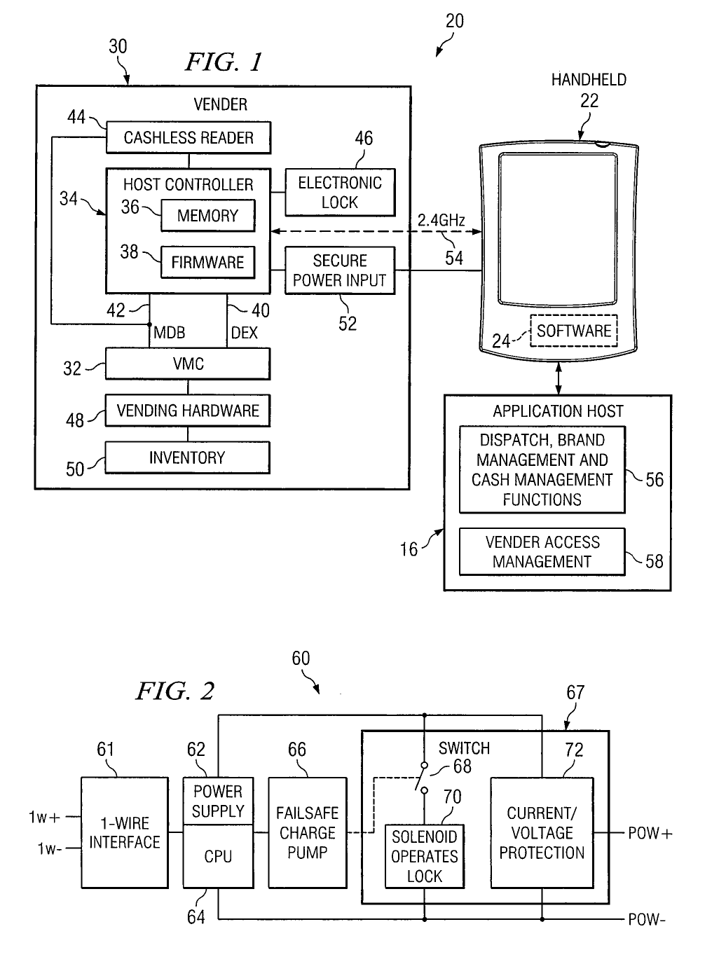

Preferred embodiments of the disclosure and its advantages are best understood by reference to FIGS. 1-5 wherein like number refer to same and like parts.

The term “remotely located equipment” may include, but is not limited to, vending machines, snack machines, beverage machines, automatic teller machines (ATMs), postage stamp dispensers, parking meters, electronic highway toll booths, arcade games, slot machines and laundry machines, or any other electronic sales machine that allows payment to be exchanged for goods or services.

Various aspects of the present disclosure may be described with respect to keys, locks and lock assemblies. The term electromechanical lock assembly may be used to describe a lock having mechanical locking components and electronic locking components. An electronic or mechanical type key may be satisfactorily used to lock and unlock the mechanical locking structure. The electronic locking structure may include a solenoid, linear actuator or other suitable electronic components which may be used to activate the electronic locking structure.

The terms “command code” and “actuation code” may be used to describe a sequence of electronic signals or digital signals which may be used to actuate one or more components of an electronic locking structure. Various types of electronic signals and digital protocols have previously been used to actuate electronic locks. Various types of encryption mechanisms and digital protection systems such as “public keys” and “private keys” have been used to control access to information on computers.

The terms “unique signal” and “nonpublic signal” may be used in their application to describe one or more electronic signals which may be included in a command code to actuate an electronic lock. The command code may include one or more publicly available signals or public keys. Forming a command code or actuation code with at least one nonpublic signal or unique signal in accordance with teachings of the present disclosure may be used to substantially increase the security and reliability of an electromechanical locking assembly used to control access at remotely located equipment.

Various aspects of the present disclosure may be described with respect to vending machine 30. However, an access control module incorporating teachings of the present disclosure may be used with various types of remotely located equipment.

FIG. 1 is a schematic drawing showing a block diagram of a vending machine and portions of a system for collecting, storing and communicating data and other information associated with operation of the vending machine. The data may include the status of various components associated with the vending machine and transactions conducted at the vending machine. For some applications an access control module incorporating teachings of the present disclosure may be used to store one or more electronic signals or commands which control access to the vending machine or other types of remotely located equipment.

Data collecting, storing and communication system 20 may be satisfactorily used with vending machine 30 and other types of remotely located equipment. System 20 may also include handheld device 22 and application host 16. Vending machine 30 as shown in FIG. 1 may include vending machine controller (VMC) 32 operable to control and monitor various electronic components and mechanical components associated with vending machine 30. Vending machine controller 32 may also include host controller 34 having memory 36 and firmware 38. In one embodiment, host controller 34 may be an audit device. Host controller 34 may be operable to obtain DEX data via DEX interface or communication link 40 from vending machine controller 32. Host controller 34 may also be operable to obtain multi-drop bus (MDB) data via MDB interface or communication link 42 from vending machine controller 32. Host controller 34 may also obtain MDB data from various peripherals including, but not limited to, cashless reader 44. Host controller 34 may archive or store the DEX data and MDB data in memory 36.

Vending machine 30 may also include one or more hardware devices or peripheral devices operable to accept cash, noncash payment tokens and/or wireless payments. Cashless reader 44 may be representative of such hardware devices and peripherals. Cashless reader or cashless media device 44 may be operable to accept noncash payment tokens such as credit cards, RFID (Radio Frequency Identification Devices) or other media representative of noncash payment.

For example vending machine controller 32 may be used to communicate data to host controller 34 and to communicate data from host controller 34 to an application host 16 and/or a network operations center (not expressly shown).

Vending machine 30 may include electronic lock 46 which may also be coupled with host controller 34. Host controller 34 may be configured such that electronic lock 46 may be commanded to engage or disengage in response to signals from host controller 34. For example, host controller 34 may receive a command from handheld device 22 to initiate a sequence for unlocking electronic lock 46. In one embodiment, the unlocking sequence may include a request from host controller 34 to electronic lock 46 to obtain a serial number associated with electronic lock 46. Host controller 34 may use the serial number associated with electronic lock 46 to compute a unique key (sometimes referred to as “computed unique key”), such as a hash code, that may be used to open electronic lock 46.

Host controller 34 may communicate the computed unique key to electronic lock 46. In one embodiment, electronic lock 46 may include an access control module (ACM) operable to store the serial number associated with electronic lock 46. The ACM may additionally be operable to store a unique key (sometimes referred to as “stored unique key”), such as a hash code, associated with the serial number. The ACM may receive the computed unique key from host controller 34 and compare the computed unique key to the stored unique key in the ACM. If the two keys match, host controller 34 may operate electronic lock 46 by supplying appropriate power and/or digital control signals thereto.

To enable electronic lock 46 to be engaged or disengaged, host controller 34 may include an electronic lock interface that facilitates a response to a request from handheld device 22 to command electronic lock 46 on vending machine 12 to open or close. In one embodiment, the electronic lock interface may be implemented using a four-wire interface connecting a twenty (20) volt DC driver, a power ground line, a digital data line and a data ground line. The digital data line may be used to command electronic lock 46 to engage and disengage, as required.

To provide operational status feedback to a user, audit device 34 may include a user interface subsystem. In one embodiment, the user interface subsystem may include one or more light emitting diodes (LED) operable to communicate operational status feedback as to one or more aspects of host controller 34 and/or vending machine 30. The user interface subsystem may also include a reset button and a MDB-snoop on/off switch. According to teachings of the present disclosure, a secondary user interface subsystem may be made available, such as via software 24, through handheld device 22.

Vending machine 30 may also include vending hardware 48 and vending inventory 50. Examples of vending machine hardware 48 may include, but are not limited to, one or more inventory dispensing apparatus, one or more coin acceptance and verification mechanisms, one or more bill acceptance and validation mechanisms or any other hardware device associated with vending machines.

Vending machine 30 may also include secure power input 52 operably coupled to host controller 34. For some applications secure power input 52 may be used to provide power to host controller 34 in the event of power failure to vending machine 30 or at other selected time periods. Secure power input 52 may include an interface including a contact point externally available on vending machine 30 together with one or more suppression and power conditioning hardware devices operable to guard against attack. As shown in FIG. 1, secure power input 52 may be connected with handheld device 22 via link or interface 54 such that host controller 34 may be powered by handheld 22. Link or interface 54 may include a contact point external to vending machine 30 along with one or more suppression and power conditioning hardware devices (not expressly shown) to guard against attack.

Handheld device 22 may be operable to communicate with host controller 34 using software application 24 and at least wireless communications 40. Handheld device 22 and host controller 34 may be equipped with one or more wireless transceivers. Examples of wireless communications that may be satisfactorily used with handheld device 22 and host controller 34 include, but are not limited to, Bluetooth, IEEE802.11a, IEEE802.11b and IEEE802.11g. To enable vending machine 30 to communicate wirelessly with handheld device 22, host controller 34 and handheld device 22 may include Bluetooth transceivers. In part for purposes of fail-over or redundancy, vending machine 30 and handheld device 22 may also include wired or wire line communication connection capabilities.

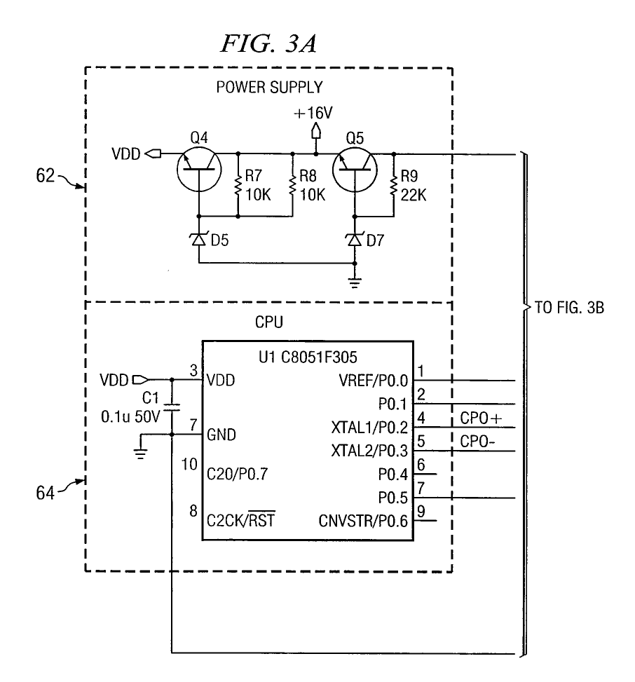

FIG. 2 is a schematic block diagram showing one example of an access control module (ACM) designed to withstand electrical and electronic attacks. As described above in reference to FIG. 1, ACM 60 may be a part of electronic lock 46 and may be used to control solenoid 70 that, when activated, causes a key handle to pop out of vending machine 30. The key handle may then be used to open vending machine 30 in order to restock or repair the machine and/or remove the money from the machine.

In the illustrated embodiment, ACM 30 may include interface 61, power supply 62, central processing unit (CPU) 64, fail-safe switch assembly 66 and power circuit 67. For some applications an electronic switch may be used as interface 61. Interface 61 may sometimes be referred to as “first switch 61.” Interface 61 may be an addressable switch having a signal wire and a ground wire. A wide variety of other types of electronic switches may also be used as interface 61. The signal wire may be used to interface electronic lock 46 with host controller 34 and communicate information between ACM 60 and host controller 34. The present disclosure is not limited to one-wire switches or addressable switches.

Power supply 62 may be derived from the main power signals POW+ and POW−and may be used to provide power to CPU 64. CPU 64 may be a microprocessor, a microcontroller, or any other digital or analog circuitry configured to store information and execute instructions for operating electronic lock 46. In one embodiment, CPU 64 may include one or more memory modules, such as random access memory (RAM), electrically erasable programmable read-only memory (EEPROM), a PCMCIA card, flash memory, or any other suitable selection and/or array of volatile or non-volatile memory. The memory may be used to store the serial number associated with electronic lock 46 and the unique key (e.g., hash code) used to open electronic lock 46.

In one embodiment, the serial number and unique key may be stored in the memory of CPU 64 by a manufacturer of ACM 60. Each manufacturer may select or be assigned a unique serial number to identify the particular manufacturer. The manufacturer may then generate a unique key from the serial number by selecting a unique algorithm (e.g., a hash function) and applying the algorithm to the serial number. The unique key may then be stored in the memory of CPU 64 and used to open electric lock 46.

For some applications electric lock 46 may be activated when a request is received at host controller 34 from handheld device 22. Upon receiving the request, host controller 34 may retrieve the serial number from ACM 60 and determine what algorithm should be used to calculate the respective unique key. In one embodiment, different algorithms may be stored in memory 36 of host controller 34. The determination may be based on a portion of the serial number or the complete serial number. For example, host controller 34 may use the first two or last two numbers in the serial number to determine which algorithm should be used. In other embodiments, more numbers may be used to determine the algorithm.

Once the algorithm is selected, host controller 34 may apply the algorithm to the serial number to calculate the respective unique key. Host controller 34 may communicate the unique key to ACM 60 and ACM 60 may compare the calculated unique key with the unique key stored in the memory of CPU 64. If the two keys match, CPU 64 may generate a signal that is communicated to fail-safe switch assembly 66 and voltage protection circuit 77 to activate solenoid 70 and open electric lock 46. By storing the respective unique key in ACM 60, the unique key may be restricted to a specific manufacturer such that the integrity of the system is improved. For some applications fail-safe switch assembly 66 may be described as “a charge pump.” However, other types of fail-safe switch assemblies may be satisfactorily used.

Various types of electronic components may be used to provide an interface between CPU 64 and solenoid 70. Examples of such components may include charge pump 66 and second switch 68. In operation, charge pump 66 may help to ensure that if CPU 64 crashes, runs outside of normal program boundaries or is electrically damaged, second switch 68 will not be energized which prevents sending a signal to switch 72 to activate solenoid 70 and thereby electronic lock 46 will remain closed. Charge pump 66 and second switch 68 may cooperate with each other to prevent electrical attacks that attempt to open electronic lock 64 by overpowering current voltage protection circuit 72 and/or CPU 64.

Second switch 68, when activated, may be used to provide power to solenoid 70 and open electronic lock 46. Second switch 68 may be a metal oxide semiconductor field effect transistor (MOSFET) switch or any other suitable analog or digital switch that may be used to energize solenoid 70. Current/voltage protection circuit 72 provides protection for second switch 68 and solenoid 70 against overvoltage and/or high current breakdown.

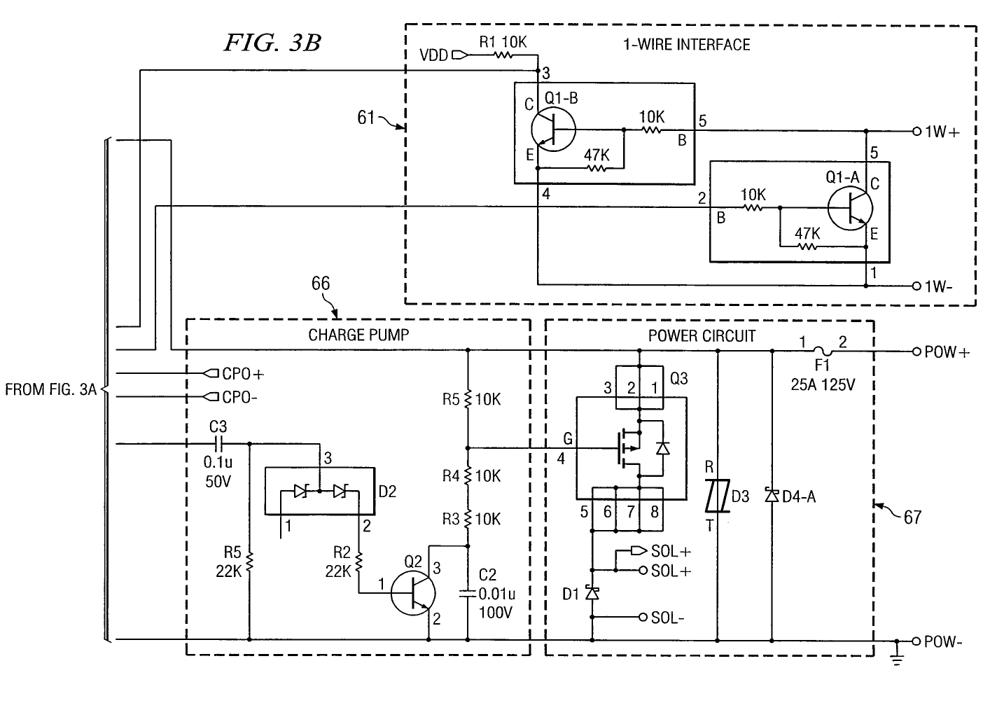

FIG. 3A is a schematic drawing showing power supply 62 and CPU 64 satisfactory for use in ACM 60. In the illustrated embodiment, power supply 62 is a stepdown regulator constructed using a two-stage zener-transistor circuit that may withstand a maximum allowable voltage of seventy volts (70V) without a failure. In other embodiments, power supply 62 may be constructed from other suitable elements that may be used to form a power supply operable to supply power to CPU 64. Although power supply 62 includes resistors having specific values, these values are for illustrative purposes only and other size resistors may be used to form power supply 62.

In the illustrated embodiment, CPU 64 includes ten (10) pins. In other embodiments, CPU 64 may include any number of pins that provide the functionality necessary to open electronic lock 46. CPU 64 may provide a secure digital means by which an authorized user may unlock electronic lock 46. In operation, handheld device 22 (as illustrated in FIG. 1) may issue a command requesting for electronic lock 46 to be opened. Host controller 34 may receive the command and send a request to ACM 60 to retrieve the serial number associated with electronic lock 46. The request may be received by ACM 60 through interface 61 and communicated to CPU 64 over signal lines 1 and/or 2.

CPU 64 may respond to the request by retrieving the unique serial number associated with electronic lock 46 from memory and communicating the serial number to interface 61 over signal lines 1 and/or 2. Host controller 34 may receive the serial number from interface 61 and use the serial number to determine what algorithm (e.g., a hash function) may be used to determine a unique key (e.g., a hash code) associated with ACM 60. In one embodiment, multiple algorithms may be stored in memory 36 of host controller 34. Host controller 34 may determine the appropriate algorithm to calculate the unique key based on at least a portion of the serial number obtained from ACM 60. In one embodiment, host controller 34 may select the algorithm by using the first or last two numbers in the serial number. In other embodiments, the algorithm may be selected by using more than two numbers in the serial number.

Once the algorithm has been selected, host controller 34 calculates the unique key by applying the algorithm to the serial number. This unique key may provide a private and secure way to unlock electronic lock 46. The calculated unique key may be communicated to CPU 64 through interface 61 and signal lines 1 and/or 2. CPU 64 may compare the calculated unique key received from host controller 34 with the unique key stored in its memory. In one embodiment, the manufacturer of ACM 60 may use a specific algorithm to calculate the unique key associated ACM 60 and may store the unique key in memory of CPU 64. If the calculated key does not match the stored key, CPU 64 determines that an unauthorized user is attempting to open electronic lock 46 and does not generate any signals. If the calculated key matches the stored key, CPU 64 determines that an authorized user is attempting to unlock electronic lock 46 and CPU 64 may generate a signal that is used to open electronic lock 46.

In one embodiment, CPU 64 may generate a specific alternating current (AC) waveform as the signal used to open electronic lock 46. The AC waveform may have a specific frequency and may be communicated to fail-safe charge pump 66 via one of the port pins of CPU 64. In the illustrated embodiment, the signal to open electronic lock 64 may be communicated to charge pump 66 through signal line 7. The pin of CPU 64 may be selected such that it cannot be driven by an internal timer or peripheral capable of generating an AC waveform outside program control. Once the signal is received by charge pump 66, the signal may be used to activate solenoid 70 in order to open electronic lock 46.

FIG. 3A is a schematic drawing showing interface 61, fail-safe charge pump 66 and power circuit 67 satisfactory for use in ACM 60. Interface 61 may provide the data communication path from host controller 34 (as illustrated in FIG. 1) and CPU 64. In the illustrated embodiment, interface 61 is implemented using two analog transistors in order to provide a layer of isolation from CPU 64. This implementation may allow interface 61 to withstand the maximum allowable voltage without a failure. In other embodiments, interface 61 may be implemented in any suitable way that allows data to be communicated between CPU 64 and host controller 34. As shown, the signals include 1W+, which represents the signal path and 1W−, which represents ground. The 1W− signal may be isolated from the power ground (POW−) such that an attack utilizing 1W− as a reference would have no effect on power circuit 67 and solenoid 70 would not be activated. Although interface 61 may include resistors having specific values, these values are for illustrative purposes only and other size resistors may be used to form interface 61.

A fail-safe switch assembly such as charge pump 66 may be used to drive second switch 68 in order to activate solenoid 70 and open electronic lock 46. Charge pump 66 and second switch 68 may be operable to prevent an unauthorized user from opening electronic lock 46 with an electrical attack. In the illustrated embodiment, resistors R6, R4, R3 and capacitor C2 are arranged such that C2 charges up to POW+ voltage and maintains second switch 68 in its off state. Additionally, charge pump 66 may be implemented such that second switch 68 is activated when transistor Q2 is turned on, which drives the voltage across C2 to zero. Transistor Q2 may be driven by a half-wave rectified charge pump implemented by capacitor C3, resistor R5 and diode D2. This charge pump may turn on Q2 when C3 is driven by a specific AC waveform provided by CPU 64. In one embodiment, the AC waveform may have a frequency above approximately 500 hertz (Hz). In other embodiments, the charge pump may be implemented such that a different frequency activates the charge pump and thus, turns on Q2. Charge pump 66, therefore, protects vending machine 30 from electrical attacks by preventing second switch 68 from being energized if CPU 64 crashes, is running out of normal program boundaries or is electrically damaged. If an electrical attack does damage CPU 64, fail-safe charge pump 66 prevents second switch 68 from being activated because the appropriate AC waveform will not be received and thus, electronic lock 46 fails in the closed state such that access to vending machine 30 will be denied.

Although fail-safe charge pump 66 is implemented in a specific way, other implementations may be used to prevent second switch 68 from being activated when an electrical attack, such as overpowering the circuits, is attempted on vending machine 30. Additionally, the resistors and capacitors in charge pump 66 have values for illustrative purposes only. Any other suitably sized resistors and capacitors may be used to implement charge pump 66.

Power circuit 67 may include second switch 68 or other suitable interface to energize solenoid 70 and open electronic lock 46. Second switch 68 may be protected from an overvoltage breakdown by a Thyristor Surge Protection Device (TSPD), a reverse biased Schottky Diode and a fuse. The TSPD may have a voltage rating well above the maximum operating voltage of vending machine 30 and the fuse rating may be selected to be well above the rated solenoid current. Additionally, the TSPD and diode power ratings may be selected such that the elements can dissipate the necessary power until the fuse blows.

Although power circuit 67 is implemented in a specific way, other implementations may be used to provide an activation mechanism for solenoid 70 and a protection mechanism for overvoltage breakdowns.

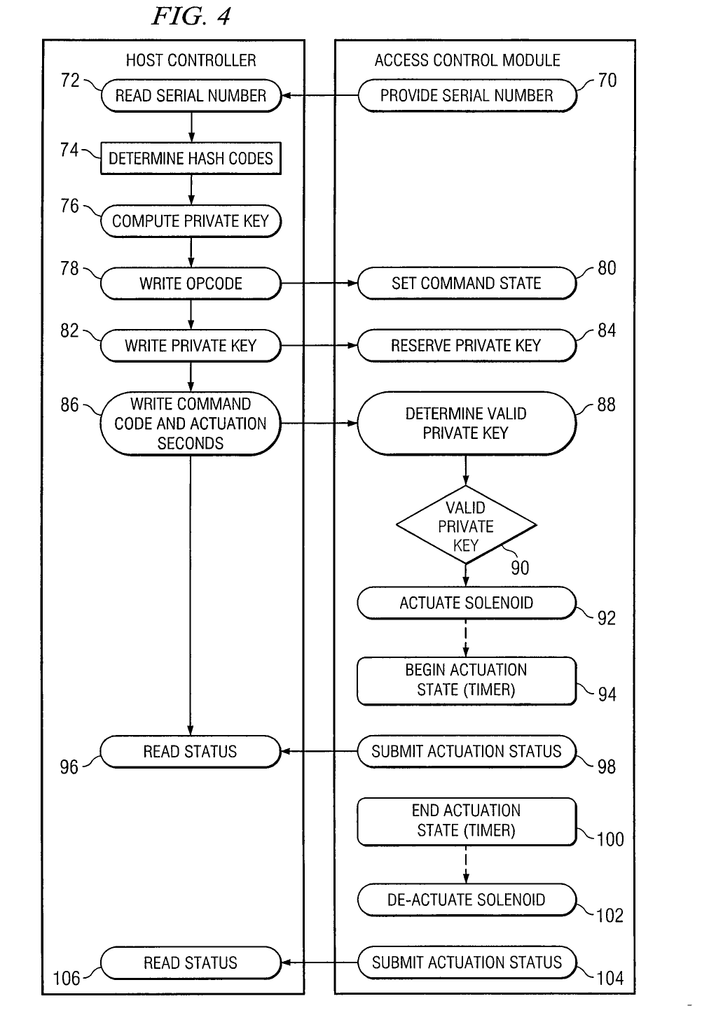

FIG. 4 is a block diagram of interaction between ACM 60 and a host controller 34 during a request to unlock electronic lock 46. At step 70, ACM 60 receives a request for the serial number stored in memory of CPU 64 and provides the serial number to host controller 34. Host controller 34 reads the received serial number at step 72. Based on the serial number, host controller 34 selects an algorithm (e.g., hash function) to calculate a unique key at step 74. In one embodiment, host controller 34 may use a portion of serial number to determine the algorithm needed to calculate the unique key. In another embodiment, host controller may use the entire serial number to determine the algorithm needed to calculate the unique key. The different algorithms used to calculate a unique key may be stored in memory 35 of host controller 34. In one embodiment, each algorithm may be associated with a different manufacturer of ACM 60. In another embodiment, multiple algorithms may be associated with a single manufacturer.

At step 76, host controller computes the unique key, also referred to as a private key, by applying the selected algorithm to the serial number. Host controller writes an opcode associated with the computed unique key at step 78 and instructs ACM 60 to set a command state associated with the opcode at step 80. At step 82, host controller 34 communicates the calculated unique key to ACM 60. ACM 60 then reserves the computer unique key at step 84.

At step 86, host controller 34 communicates the command code and actuation time for solenoid 70 to ACM 60. Once ACM 60 has received the computed unique key, ACM 60 determines if the computed unique key is valid at step 88. In one embodiment, ACM 60 determines if the computed unique key is valid by comparing it to a unique key stored in the memory of CPU 64. If ACM 60 determines that the computed unique key is not valid, ACM 60 does not generate a signal to activate solenoid 70. If ACM 60 determines that the computer unique key is valid, ACM 60 generates a signal that is passed to charge pump 66 in order to activate solenoid 70 at step 92.

Once solenoid 70 is energized, ACM 60 starts an actuation timer at step 94. The amount of time that solenoid 70 is actuated may be set by host controller 34 in step 86. At step 98, ACM 60 determines the actuation status of solenoid 70 and communicates the status to host controller 34. Host controller 34 reads the received status at step 96. If host controller 34 determines that solenoid 70 has been energized, host controller 34 may communicate to handheld device 22 that the request to open electronic lock 46 was successful. In host controller 34 determines that solenoid 70 was not energized, host controller 34 may communicate an error message to handheld device 22.

At step 100, the actuation timer may end and ACM 60 may de-actuate solenoid 70 in order to close electronic lock 46 at step 102. At step 104, ACM 60 determines the actuation status of solenoid 70 and communicates the status to host controller 34. Host controller 34 reads the received status at step 106.

Although the present disclosure and its advantages have been described in detail, it should be understood that various changes, substitutions and alterations can be made herein without departing from the spirit and scope of the disclosure as defined by the following claims.

What is claimed is:

1. An access control module (ACM) operable to prevent unauthorized activation of an electronic locking structure to gain access to remotely located equipment, comprising:
a first interface operable to receive an electronic signal from a host controller, the electronic signal including a computed unique key;
a microprocessor interfaced with the first switch; and
the microprocessor operable to:
store a serial number and a unique key associated with the ACM;
compare the computed unique key with the stored unique key; and
generate an actuation signal for the electronic locking structures if the computed unique key matches the stored unique key.

2. The access control module of claim 1, wherein the actuation signal comprises a predetermined alternating current (AC) waveform.

3. The access control module of claim 1 further comprising:
a fail-safe switch assembly interfaced with the microprocessor; and
the fail-safe switch assembly operable to close a second switch to activate portions of at least one component of the electronic locking structure in response to the actuation signal provided by the microprocessor.

4. The access control module of claim 3, further comprising:
a solenoid coupled to the second switch; and
the solenoid operable to open portions of the electronic locking structure when the solenoid has been energized.

5. The access control module of claim 4, further comprising a timer operable to deactivate the solenoid after the second switch has been closed for a selected time interval.

6. The access control module of claim 3, wherein the second switch comprises a MOSFET switch.

7. The access control module of claim 1, wherein the computed unique key and the stored unique key comprise hash codes.

8. The access control module of claim 1, wherein the first interface comprises an addressable switch.

9. A method for controlling access to remotely located equipment comprising:
receiving a request at an access control module (ACM) from a host controller to provide a serial number associated with the ACM;
communicating the serial number to the host controller;
in response to communicating the serial number to the host controller, receiving a calculated unique key from the host controller;
comparing the calculated unique key with a unique key stored in a microprocessor associated with the ACM;
generating an actuation signal if the calculated unique key matches the stored unique key; and
communicating the actuation signal to activate at least one component of an electronic locking structure.

10. The method of claim 9, further comprising the host controller computing the calculated unique key by:
selecting an algorithm based on at least a portion of the serial number; and
applying the selected algorithm to the serial number.

11. The method of claim 10, further comprising computing the calculated unique key in part by the algorithm using a hash function associated with a manufacturer.

12. The method of claim 9, further comprising using a predetermined alternating current (AC) waveform to provide at least a portion of the actuation signal.

13. The method of claim 9 further comprising using a charge pump to close a switch to activate the at least one component.

14. The method of claim 9, further comprising using at least one interface to provide overpower protection for the electronic locking structure.

15. The method of claim 9, further comprising deactivating the at least one component of the electronic locking structure when a timer expires.

16. An access control module (ACM) operable to prevent unauthorized activation of an electronic locking structure which controls access to remotely located equipment, comprising:
a first interface operable to receive an electronic signal including a computed unique key;
a microprocessor operably coupled with the first interface; and
the microprocessor operable to:
store a serial number and unique key associated with the ACM;
the microprocessor further operable to compare the unique key with the stored unique key;
the microprocessor operable to generate an actuation signal for the electronic locking structure if the computed unique key matches the stored unique key;
a second interface operably coupled with the microprocessor; and
the second interface operable to prevent unauthorized activation of at least portions of the electronic locking structure.

17. The access control module of claim 16, wherein the first interface further comprises an addressable switch.

18. The access control module of claim 17 wherein the addressable switch further comprises a one-wire switch.

19. The access control module of claim 16 wherein the second interface comprises a fail-safe charge pump and a second switch.

20. The access control module of claim 19, further comprising:
a solenoid coupled to the second switch; and
the solenoid operable to open portions of the electronic locking structure when the solenoid has been energized.

21. The access control module of claim 16, wherein the computer unique key and the stored unique key comprise hash codes.
